(19) United States
(12) Patent Application Publication
(10) Pub. No.: US 2025/0192470 A1
(43) Pub. Date: Jun. 12, 2025

(54) CONNECTOR

(71) Applicant: SUMITOMO WIRING SYSTEMS, LTD., Mie (JP)

(72) Inventors: Shiori OZEKI, Mie (JP); Keishi KITAMURA, Mie (JP)

(21) Appl. No.: 18/843,706

(22) PCT Filed: Feb. 16, 2023
(86) PCT No.: PCT/JP2023/005364

§ 371 Date: Sep. 4, 2024

(30) Foreign Application Priority Data
Mar. 8, 2022 (JP) 2022-035247

(51) Int. Cl. H01R 13/52; H01R 13/629

(52) U.S. Cl. CPC H01R 13/52; H01R 13/629

(57) ABSTRACT

A connector (10) includes a housing body (21) connectable to a mating housing (90) from front and a resiliently deformable lock arm (47) extending in a front-rear direction and configured to lock the mating housing (90). A pressing portion (53) for releasing locking with the mating housing (90) by being pressed toward one surface side of the housing body (21) is formed in a rear end part of the lock arm (47). An external matter discharge portion (40) is formed closer to the one surface side of the housing body than the pressing portion (53).

### TECHNICAL FIELD

The present disclosure relates to a connector.

### BACKGROUND

A connector of Patent Document 1 is provided with a housing and a lock arm coupled to the housing. The lock arm extends in a front-rear direction and is resiliently deformable like a seesaw. This lock arm locks a mating housing and holds the housing and the mating housing in a connected state. A rear end part of the lock arm is formed with a pressing portion. The pressing portion is pressed toward the housing in releasing the locking of the housing and the mating housing. A connector provided with such a lock arm is also disclosed in Patent Document 2, 3 and 4.

### PRIOR ART DOCUMENT

### Patent Document

Patent Document 1: JP 2001-110511 A
Patent Document 2: JP 2001-167848 A
Patent Document 3: JP 2002-280108 A
Patent Document 4: JP 2006-172754 A

### SUMMARY OF THE INVENTION

### Problems to be Solved

Depending on a situation where the connector is installed, an external matter such as mud may enter a space between the housing and the pressing portion from outside. If the external matter deposited in the space remains, the pressing portion cannot be properly pressed and affects operability in unlocking the lock arm.

Accordingly, the present disclosure aims to provide a connector capable of ensuring operability at the time of unlocking a lock arm.

### Means to Solve the Problem

The present disclosure is directed to a connector with a housing body connectable to a mating housing from front, a resiliently deformable lock arm extending in a front-rear direction, the lock arm locking the mating housing, a pressing portion formed in a rear end part of the lock arm, the pressing portion releasing locking with the mating housing by being pressed toward one surface side of the housing body, and an external matter discharge portion formed closer to the one surface side of the housing body than the pressing portion.

### Effect of the Invention

According to the present disclosure, it is possible to provide a connector capable of ensuring operability at the time of unlocking a lock arm.

### BRIEF DESCRIPTION OF THE DRAWINGS

FIG. 1 is a back view of a housing in a connector according to a first embodiment of the present disclosure.

FIG. 2 is a partial enlarged perspective view of the housing.

FIG. 3 is a side view in section of the housing.

FIG. 4 is a plan view of the housing.

FIG. 5 is a partial enlarged perspective view of the housing cut in a lateral central part.

FIG. 6 is a partial enlarged side view in section showing a lock arm in a natural state in the housing.

FIG. 7 is a partial enlarged side view in section showing the resiliently deformed lock arm in the housing.

FIG. 8 is an enlarged back view showing an essential part of a lock arm in a connector according to a second embodiment of the present disclosure when viewed from behind.

### DETAILED DESCRIPTION TO EXECUTE THE INVENTION

### Description of Embodiments of Present Disclosure

First, embodiments of the present disclosure are listed and described.

(1) The connector of the present disclosure is provided with a housing body connectable to a mating housing from front, a resiliently deformable lock arm extending in a front-rear direction, the lock arm locking the mating housing, a pressing portion formed in a rear end part of the lock arm, the pressing portion releasing locking with the mating housing by being pressed toward one surface side of the housing body, and an external matter discharge portion formed closer to the one surface side of the housing body than the pressing portion.

According to the above configuration, the external matter discharge portion can discharge an external matter having entered between the one surface side of the housing body and the pressing portion. Thus, also under a situation where an external matter enters between the one surface side of the housing body and the pressing portion, an operation of releasing the locking of the lock arm and the mating housing, i.e. a pressing operation of the pressing portion, can be performed.

(2) Preferably, a slope portion serving as the external matter discharge portion and inclined in a direction separating from the pressing portion toward a rear side is provided at a position facing the pressing portion on the one surface side of the housing body.

According to the above configuration, even if an external matter is deposited between the one surface side of the housing body and pressing portion, the external matter can be pushed out from the slope portion according to the pressing operation of the pressing portion.

(3) A rib may be provided which projects from the housing body toward the pressing portion, and the slope portion may include a first slope portion on an end part on a tip side in a projecting direction of the rib.

According to the above configuration, since the first slope portion is closely facing the pressing portion, the external matter deposited on the first slope portion can be effectively pushed out by the pressing portion.

(4) An open portion, the open portion being a gap open rearward, may be provided between the pressing portion and the first slope portion in a state where the pressing portion is closest to the one surface side of the housing body.

According to the above configuration, since the discharge of the external matter can be promoted by the open portion, the external matter is less likely to stay between the one surface side of the housing body and the pressing portion.

(5) The slope portion may include a flat and inclined second slope portion at a position adjacent to the rib on the one surface side of the housing body.

According to the above configuration, the external matter can be discharged also from the second slope portion in addition to the first slope portion, and is even less likely to stay between the one surface side of the housing body and the pressing portion.

(6) A projecting portion may be provided which projects from at least one of the housing body and the pressing portion toward the other, and the projecting portion may include a tapered portion serving as the external matter discharge portion and having a thickness reduced toward the other.

According to the above configuration, the external matter deposited between the one surface side of the housing body and the pressing portion can be pushed away and discharged by the tapered portion of the projecting portion according to the pressing operation of the pressing portion.

(7) The projecting portion may be composed of a rib projecting from the housing body toward the pressing portion and a facing rib projecting from the pressing portion toward the housing body, and the tapered portions of the rib and the facing rib may be facing each other.

According to the above configuration, the external matter deposited between the one surface side of the housing body and the pressing portion can be effectively pushed out from between the tapered portion of the rib and the tapered portion of the facing rib according to the pressing operation of the pressing portion.

### Details of Embodiments of Present Disclosure

Specific examples of the present disclosure are described below with reference to the drawings. Note that the present invention is not limited to this illustration, but is represented by claims and intended to include all changes in the scope of claims and in the meaning and scope of equivalents.

### First Embodiment

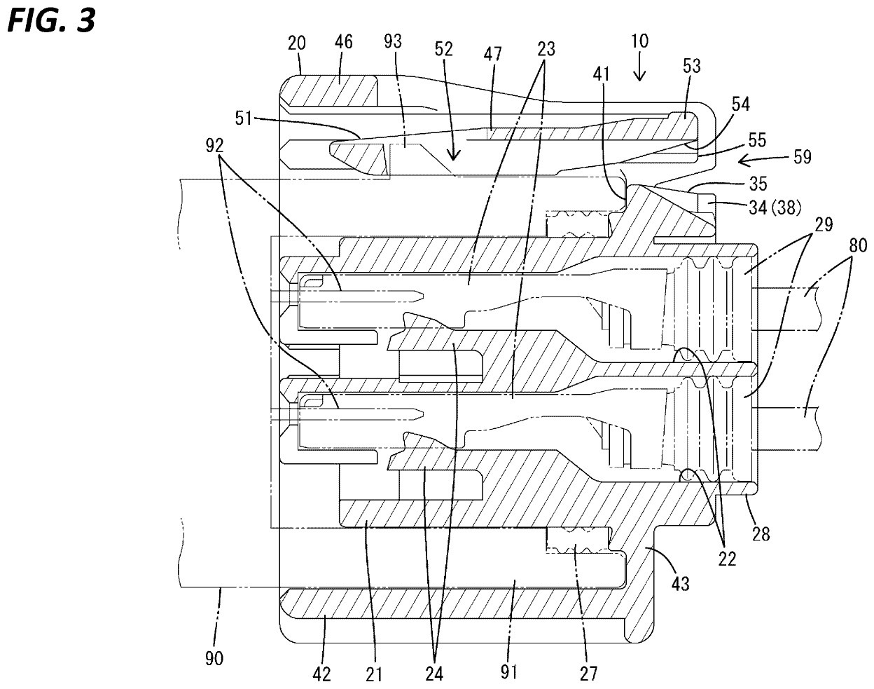

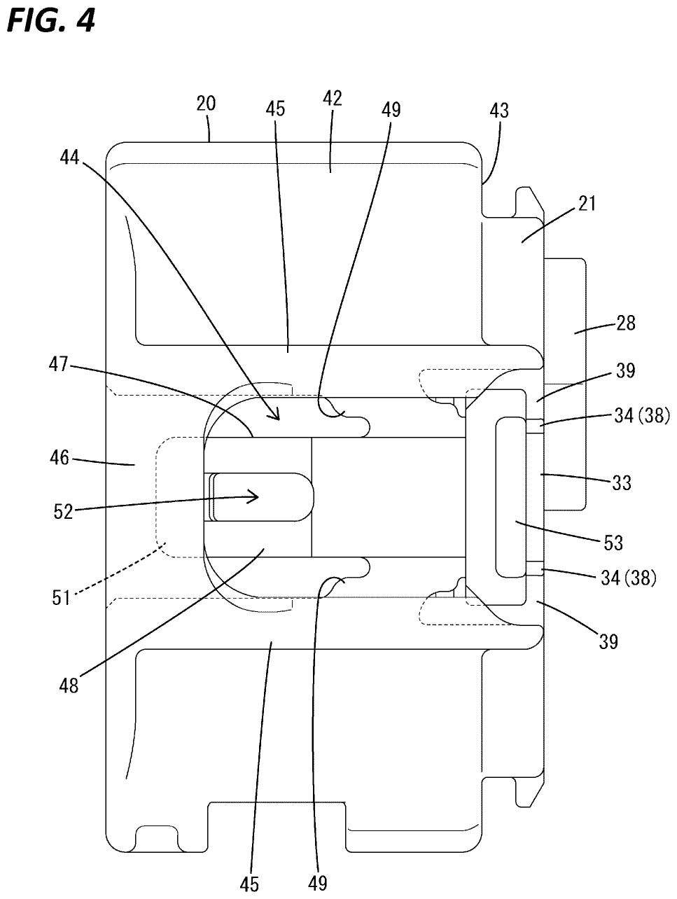

A connector 10 according to a first embodiment is provided with a housing 20 made of synthetic resin. The housing 20 is connected to a mating housing 90. Note that, in the following description, a side of the housing 20 to be connected to the mating housing 90 is referred to as a front side concerning a front-rear direction. A left side of FIG. 3 is the front side. A vertical direction is based on a vertical direction of each figure except FIG. 4. The vertical direction is synonymous with a height direction. A lateral direction is synonymous with a width direction. These directions do not necessarily coincide with directions in a state where the connector 10 is installed in an unillustrated vehicle or the like.

As shown in FIG. 3, the mating housing 90 includes a tubular receptacle 91. A plurality of mating terminal fittings 92 project into the receptacle 91. A mating lock portion 93 is provided to project on the upper wall of the receptacle 91.

As shown in FIG. 3, the housing 20 includes a housing body 21 to be fit into the receptacle 91. The housing body 21 includes a plurality of cavities 22. A terminal fitting 23 is inserted into each cavity 22 from behind. The housing body 21 includes locking lances 24 projecting forward from the inner surfaces of the respective cavities 22. The terminal fitting 23 is locked by the locking lance 24 and primarily retained in the cavity 22. The terminal fitting 23 is crimped to an end part of a wire 80 and electrically connected to the mating terminal fitting 92 at the time of connecting the housing 20 and the mating housing 90.

An unillustrated retainer is assembled with the housing body 21 from a lateral side. The retainer secondarily retains the terminal fittings 23. A sealing ring 27 is mounted on the outer peripheral surface of the housing body 21. The sealing ring 27 is sandwiched between the housing body 21 and the receptacle 91 in a liquid-tight manner.

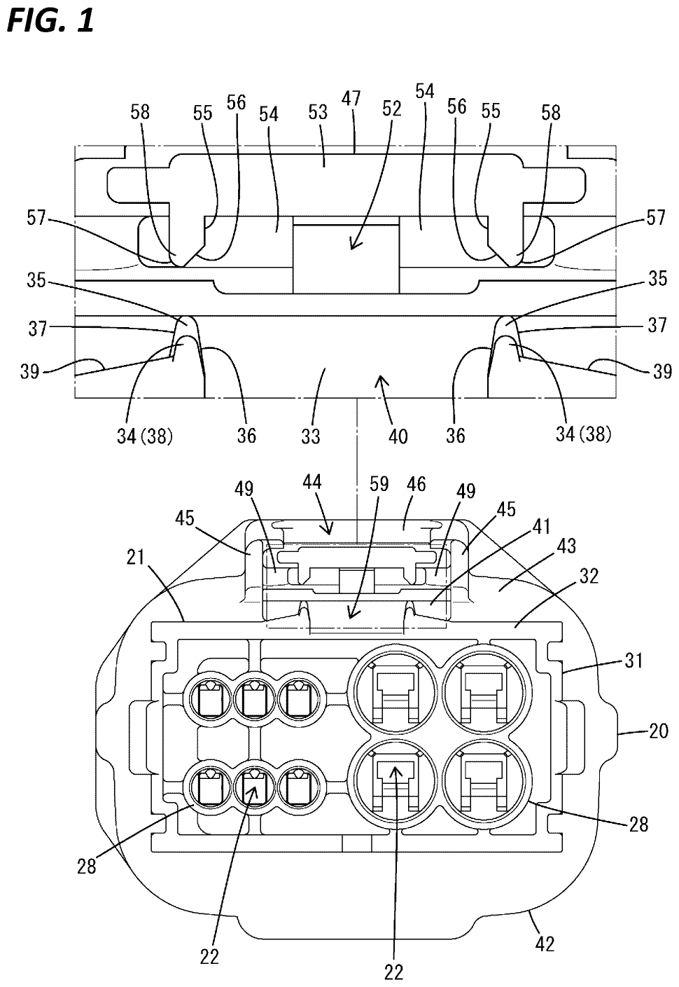

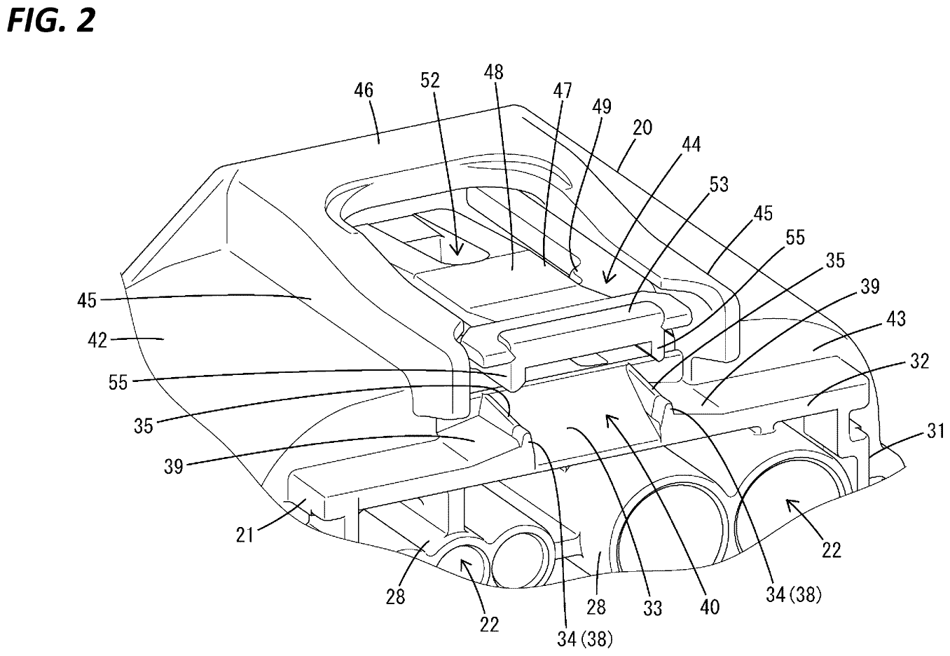

As shown in FIGS. 1 and 2, the housing body 21 includes a plurality of cavity tower portions 28. Each cavity tower portion 28 has a hollow cylindrical shape and projects rearward from the housing body 21. A rear part of each cavity 22 is formed in each cavity tower portion 28. As shown in FIG. 3, a rubber plug 29 fit to the outer peripheral surface of the wire 80 is inserted in a liquid-tight manner in each cavity tower portion 28.

The housing body 21 includes a frame portion 31 for collectively surrounding the respective cavity tower portions 28 in a rear end part. As shown in FIG. 1, the frame portion 31 has a rectangular shape in a back view and includes an upper side portion 32 in the form of a plate horizontal in the lateral direction.

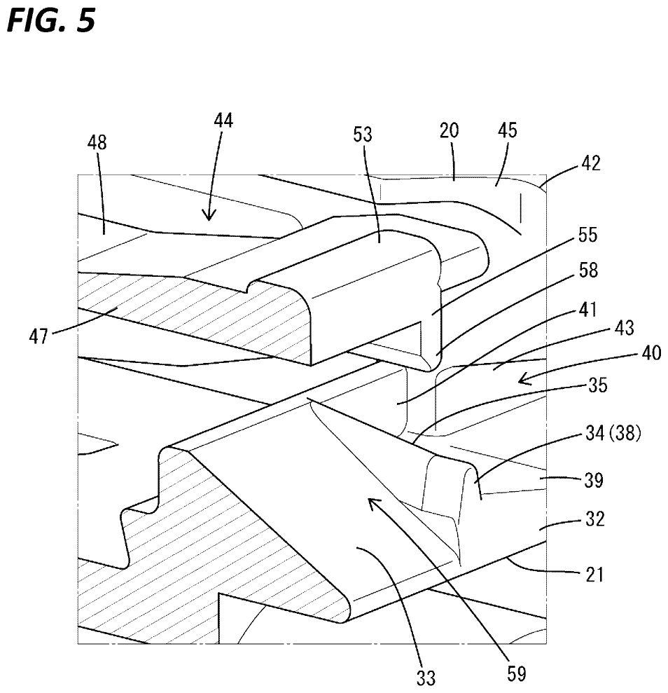

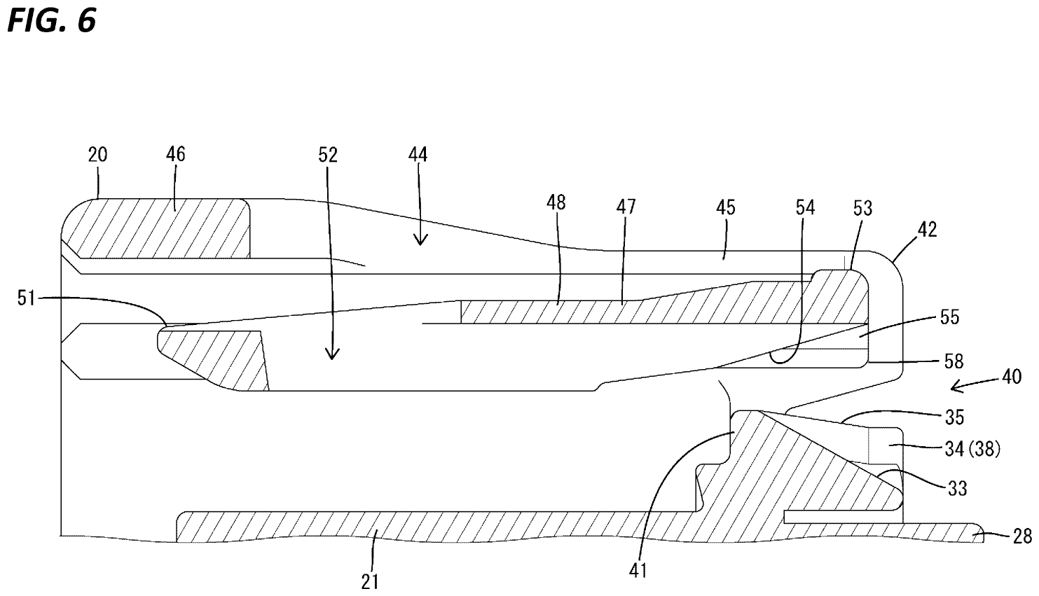

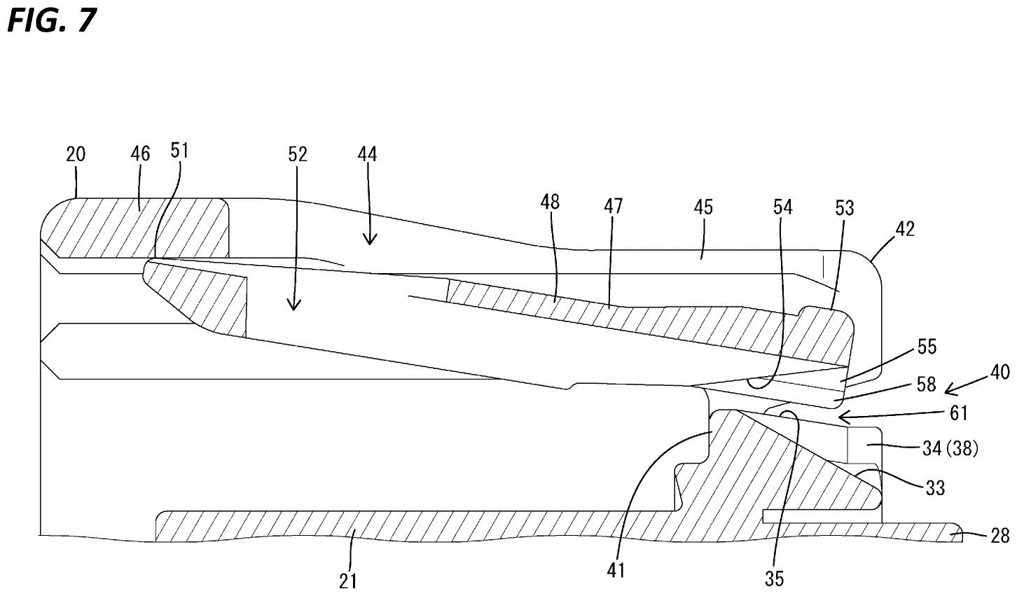

The housing body 21 includes a second slope portion 33 serving as a slope portion inclined downward toward a rear side on the upper surface (one surface) of a lateral central part of the upper side portion 32. As shown in FIGS. 2 and 5, the second slope portion 33 is a smooth and continuous flat inclined surface and inclined at a certain angle of inclination to the front-rear direction. As shown in FIGS. 6 and 7, a rear end part of the second slope portion 33 is arranged at a position facing the large-diameter cavity tower portion 28 from above.

As shown in FIG. 1, the housing body 21 includes ribs 34 serving as a pair of projecting portions projecting upward (toward a pressing portion 53 to be described later) from positions adjacent to both left and right end parts of the second slope portion 33 on the upper surface of the upper side portion 32. The respective ribs 34 are shaped to extend in the front-rear direction while being connected to the both left and right end parts of the second slope portion 33.

Each rib 34 includes a first slope portion 35 serving as a slope portion inclined downward toward the rear side on an upper end part (end part on a tip side in a projecting direction of the rib 34) thereof. As shown in FIGS. 6 and 7, the first slope portion 35 is a top part of the rib 34 and inclined at a certain angle of inclination gentler than the second slope portion 33 to the front-rear direction. A front end part of the first slope portion 35 is adjacent to a front end part of the second slope portion 33 at the same height.

As shown in FIG. 1, the respective ribs 34 have inner slants 36 inclined toward a lateral central part of the housing body 21 from the first slope portions 35 (upper end parts) to the second slope portion 33 (lower end parts) on inner surfaces facing each other in the lateral direction. The respective ribs 34 have outer slants 37 inclined away from the lateral central part of the housing body 21 from the first slope portions 35 toward lower sides on outer surfaces on sides opposite to the inner slants 36. In the case of the first embodiment, the inner and outer slants 36, 37 are respectively inclined at an angle of inclination of 45° or less, preferably 30° or less to the vertical direction. Each rib 34 is configured as a tapered portion 38 having a tapered shape gradually narrower toward the first slope portion 35 by the inner and outer slants 36, 37.

As shown in FIG. 1, the housing body 21 includes third slope portions 39 inclined away from the lateral central part of the housing body 21 at positions adjacent to the outer slants 37 of the respective ribs 34 on the upper surface of the upper side portion 32. The third slope portion 39 is a smooth continuous flat surface and inclined at a certain angle of inclination gentler than the outer slant 37 to the lateral direction.

As shown in FIG. 5, the housing body 21 includes a weir portion 41 projecting upward from a front end part of the upper side portion 32. The weir portion 41 is in the form of a transverse wall coupled to the front end part of each of the second slope portion 33, the ribs 34 and the third slope portions 39 and extending in the lateral direction. An upper end part of the weir portion 41 is arranged at the same height as the front end part of each of the first slope portions 35 and the second slope portion 33. As shown in FIG. 3, the sealing ring 27 mounted on the outer peripheral surface of the housing body 21 is arranged in front of the weir portion 41.

The first slope portions 35, the second slope portion 33, the third slope portions 39 and the tapered portions 38 (inner slants 36, outer slants 37) of the ribs 34 constitute an external matter discharge portion 40 capable of discharging an external matter such as mud having entered the housing 20, together with tapered portions 58 (facing inner slants 56, facing outer slants 57) of facing ribs 55 to be described later.

As shown in FIG. 3, the housing 20 includes a fitting tube portion 42 surrounding the outer periphery of the housing body 21. The receptacle 91 of the mating housing 90 is fit between the fitting tube portion 42 and the housing body 21. The fitting tube portion 42 includes a back wall portion 43 radially protruding from a front end part of the frame portion 31 on a rear end part.

As shown in FIGS. 2 and 4, the fitting tube portion 42 includes an opening 44 penetrating through a lateral central part of an upper wall, a pair of protecting portions 45 defining both left and right end parts of the opening 44, a reverse turning restricting portion 46 defining a front end part of the opening 44 and a lock arm 47 arranged resiliently deformably in the opening 44.

The respective protecting portions 45 extend in the front-rear direction and are facing each other via the opening 44. As shown in FIG. 1, both circumferential end parts of the back wall portion 43 are respectively coupled to the respective protecting portions 45. The weir portion 41 is coupled to the both circumferential end parts of the back wall portion 43 between the respective protecting portions 45. As shown in FIG. 2, the reverse turning restricting portion 46 is in the form of a horizontal plate and provided to extend in the lateral direction between upper parts of the front ends of the respective protecting portions 45. The respective protecting portions 45 protect the lock arm 47 from both left and right sides. The reverse turning restricting portion 46 is arranged to be able to restrict a displacement of the lock arm 47 in a reverse direction (excessive upward displacement).

As shown in FIG. 4, the lock arm 47 includes a lock body 48 in the form of a rectangular plate long in the front-rear direction and a pair of fulcrum portions 49 respectively extending sideways (in particular, obliquely forward) from both left and right end parts of the lock body 48 and coupled to the respective protecting portions 45. The lock body 48 is resiliently deformable (displaceable to tilt) like a seesaw with the respective fulcrum portions 49 as fulcrums.

The lock body 48 includes an interfering portion 51 facing the reverse turning restricting portion 46 from below in a front end part. As shown in FIG. 7, the interfering portion 51 interferes with the reverse turning restricting portion 46 when the lock arm 47 is turned in the reverse direction.

As shown in FIG. 4, the lock body 48 includes a lock hole 52 penetrating in the vertical direction through a part behind the interfering portion 51 and in front of the respective fulcrum portions 49. As shown in FIG. 3, the mating lock portion 93 is fit into the lock hole 52 of the lock body 48. In this way, the housing 20 and the mating housing 90 are held in a connected state.

As shown in FIG. 4, the lock arm 47 includes the pressing portion 53 wider than the lock body 48 behind the lock body 48. A rear end part of the pressing portion 53 is arranged behind the back wall portion 43. As shown in FIG. 6, when the lock arm 47 is in a natural state, the upper surface of the pressing portion 53 is arranged at a position higher than that of the lock body 48 and exposed upward through the opening 44. By pressing the pressing portion 53 from above, a front end part of the lock body 48 is displaced upward, the mating lock portion 93 comes out from the lock hole 52 and the locking of the mating lock portion 93 and the lock arm 47 can be released.

The lock hole 52 is open rearward of the lock arm 47 through a lateral central part of the lower surface of the pressing portion 53. As shown in FIGS. 1, 6 and 7, a pair of retracted surfaces 54 inclined upward toward the rear side are formed on both left and right sides of the lower surface of the pressing portion 53.

As shown in FIG. 1, the lock arm 47 includes the facing ribs 55 serving as a pair of projecting portions projecting downward (toward the housing 21) from end parts on both left and right sides across the respective retracted surfaces 54 on the lower surface of the pressing portion 53. Each facing rib 55 extends in the front-rear direction while being connected to each retracted surface 54 and a front end part thereof is arranged close to (adjacent to) each fulcrum portion 49. As shown in FIG. 6, when the lock arm 47 is in the natural state, a lower end part of each facing rib 55 is horizontally arranged along the front-rear direction.

As shown in FIG. 1, the respective facing ribs 55 have the facing inner slants 56 inclined toward a lateral central part of the pressing portion 53 from lower end parts toward upper sides on inner surfaces facing each other in the lateral direction. The facing inner slant 56 is formed by cutting a range of more than half the inner side, out of the entire width of the facing rib 55. The respective facing ribs 55 have the facing outer slants 57 inclined away from the lateral central part of the pressing portion 53 from lower end parts toward upper sides on outer surfaces on sides opposite to the facing inner slants 56. The facing outer slant 57 is formed in a range narrower than the facing inner slant 56. The shown facing outer slant 57 is formed as a curved slant. Each facing rib 55 is formed with the tapered portion 58 having a tapered shape gradually narrower toward the lower end part by the facing inner slant 56 and the facing outer slant 57. A lower end part of the tapered portion 58 of each facing rib 55 and an upper end part of the tapered portion 38 of each rib 34 are facing each other in the vertical direction and restrict excessive pressing of the pressing portion 53 by butting against each other.

The structure of the connector 10 according to the first embodiment is as described above. Next, functions of the connector 10 are described.

When the housing 20 and the mating housing 90 are in the connected state, an external matter such as mud may enter the housing 20 depending on a situation where the connector 10 is installed. If the external matter enters a space 59 (see FIGS. 1 and 5) between the pressing portion 53 and the housing body 21, which is a deflection space for the lock arm 47, and the pressing operation of the pressing portion 53 is hindered by the external matter, the locking of the lock arm 47 and the mating lock portion 93 cannot be released.

In contrast, in the case of the first embodiment, the first slope portions 35 are formed on the pair of ribs 34 projecting on the upper surface side (one surface side) of the housing body 21. Thus, the external matter can move rearward along the first slope portions 35 of the respective ribs 34 and drop down from the rear end parts of the first slope portions 35.

Further, the second slope portion 33 is also formed between the respective ribs 34 on the upper surface side of the housing body 21. Thus, the external matter can move rearward along the second slope portion 33 and drop down from the rear end part of the second slope portion 33. Thus, in the case of the first embodiment, the external matter hardly stays in the space 59 and the pressing portion 53 in the space 59 can be pressed (pressed down). Even if the external matter is deposited in the space 59, a lower surface side of the pressing portion 53 including the respective facing ribs 55 can push the external matter rearward and discharge the external matter according to the pressing operation of the pressing portion 53.

Furthermore, the front end part of each of the first slope portions 35 and the second slope portion 33 is coupled to the weir portion 41 in the form of a transverse wall. Thus, a movement of the external matter toward a connection area of the housing body 21 and the mating housing 90 can be restricted by the weir portion 41.

In the case of the first embodiment, as shown in FIG. 7, the pressing portion 53 is closest to the upper surface of the housing body 21 when the interfering portion 51 of the lock body 48 interferes with the reverse turning restricting portion 46 and the deflection of the lock arm 47 is restricted. In such a state where the pressing portion 53 is closest to the upper surface of the housing body 21, open portions 61 open rearward are formed between the upper end parts of the tapered portions 38 of the ribs 34 and the lower end parts of the tapered portions 58 of the facing ribs 55. Thus, the external matter deposited in the space 59 is easily discharged rearward from the open portions 61 and can be prevented from staying between the respective tapered portions 38 and 58 of the ribs 34 and the facing ribs 55. Further, in the state where the pressing portion 53 is closest to the upper surface of the housing body 21, a space open rearward and expanded in the vertical direction is also formed between the retracted surfaces 54 and the second slope portion 33. Thus, the external matter can be easily discharged from between the retracted surfaces 54 and the second slope portion 33.

Moreover, the respective tapered portions 38 and 58 of the ribs 34 and the facing ribs 55 can push away the external matter deposited in the space 59 toward both left and right sides according to the pressing operation of the pressing portion 53. For example, a part of the external matter can be moved inward by the inner slants 36 of the ribs 34 and the facing inner slants 56 of the facing ribs 55 and dropped downward from the second slope portion 33. The other part of the external matter can be moved outward by the outer slants 57 of the ribs 34 and the facing outer slants 57 of the facing ribs 55 and dropped down from the third slope portions 39.

In the case of the first embodiment, the upper end parts of the tapered portions 38 of the respective ribs 34 and the lower end parts of the tapered portions 58 of the respective facing ribs 55 are closely facing each other via the open portions 61 with the lock arm 47 resiliently deformed. Thus, the tapered portions 38, 58 of the respective ribs 34 and facing ribs 55 can apply push-out forces from both upper and lower sides to the external matter deposited in the space 59 according to the pressing operation of the pressing portion 53. Thus, the external matter can be effectively discharged from between the respective tapered portions 38 and 58 of the ribs 34 and the facing ribs 55.

As described above, the first slope portions 35, the second slope portion 33, the third slope portions 39, the respective tapered portions 38, 58 of the ribs 34 and the facing ribs 55 function as the external matter discharge portion 40 and can discharge an external matter such as mud having entered the space 59 between the pressing portion 53 and the housing body 21. Thus, an operation of releasing the locking of the lock arm 47 and the mating housing 90, i.e. the pressing operation of the pressing portion 53, can be performed.

Out of the external matter discharge portion 40, the first and second slope portions 35, 33 serving as the slope portions can move the external matter rearward along the inclined shapes thereof and discharge the external matter from the rear end part of the housing body 21. Particularly, since the first slope portions 35 are closely facing the pressing portion 53, the external matter can be effectively pushed out according to the pressing operation of the pressing portion 53.

Further, since the open portions 61 are formed between the pressing portion 53 and the first slope portions 35 in the state where the pressing portion 53 is closest to the upper surface of the housing body 21, the discharge of the external matter from the open portions 61 can be promoted and the external matter is less likely to stay between the upper surface of the housing body 21 and the pressing portion 53.

Furthermore, out of the external matter discharge portion 40, the tapered portions 38, 58 respectively formed on the ribs 34 and the facing ribs 55 serving as the slope portions can push away the external matter deposited in the space 59 toward the both left and right sides and discharge the external matter according to the pressing operation of the pressing portion 53.

### Second Embodiment

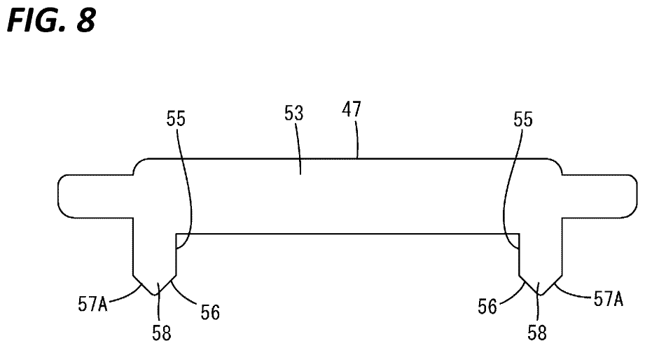

A second embodiment of the present disclosure differs from the first embodiment in the shape of a pair of facing ribs 55 formed on a lower surface side of a pressing portion 53 of a lock arm 47 as shown in FIG. 8. The other configuration is as in the first embodiment.

The respective facing ribs 55 have facing inner slants 56 inclined toward a lateral central part of the pressing portion 53 from lower end parts toward upper sides on inner surfaces facing each other in the lateral direction as in the first embodiment. The facing inner slant 56 is formed by cutting a range of nearly half the inner side, out of the entire width of the facing rib 55.

The respective facing ribs 55 have facing outer slants 57A inclined away from the lateral central part of the pressing portion 53 from lower end parts toward upper sides on outer surfaces on sides opposite to the facing inner slants 56. The facing outer slant 57A is formed in a nearly half range on an outer side, out of the entire width of the facing rib 55.

The facing inner slants 56 and the facing outer slants 57A are formed as flat surfaces inclined straight toward the upper side. Each facing rib 55 is formed with a tapered portion 58 having a tapered shape gradually narrower toward the lower end part by the facing inner slant 56 and the facing outer slant 57A.

In the case of the second embodiment, tapered portions 38, 58 respectively formed on ribs 34 and the facing ribs 55 can equally push away an external matter deposited in a space 59 toward both left and right sides and discharge the external matter according to a pressing operation of the pressing portion 53.

### Other Embodiments of Present Disclosure

The first and second embodiments disclosed this time should be considered illustrative in all aspects, rather than restrictive.

In the case of the first and second embodiments, the first and second slope portions are formed as flat surfaces inclined straight toward the rear side. In contrast, according to another embodiment, the first and second slope portions may be formed as downward concave or upward convex curved surfaces inclined in a curved manner toward the rear side.

In the case of the first and second embodiments, the lock arm is supported on the protecting portions via the fulcrum portions. In contrast, according to another embodiment, the lock arm may be supported on the housing body via leg portions rising from the upper surface of the housing body.

In the case of the first and second embodiments, the tapered portion of the rib is formed over the entire height of the rib and the tapered portion of the facing rib is formed only in the lower end part of the facing rib. In contrast, according to another embodiment, the tapered portion of the rib may be formed only in the upper end part of the rib, and the tapered portion of the facing rib may be formed over the entire height of the facing rib.

In the case of the first and second embodiments, the tapered portion of each of the ribs and the facing ribs is shaped to become narrower in thickness in the width direction toward the mating side. In contrast, according to another embodiment, the tapered portion of each of the ribs and the facing ribs may be shaped to become narrower in thickness in the front-rear direction (direction orthogonal to the plane of FIG. 1) toward the mating side.

In the case of the first and second embodiments, the pair of ribs and the pair of facing ribs are respectively formed at an interval in the lateral direction on the housing body and the pressing portion. In contrast, according to another embodiment, only one rib and only one facing rib may be formed or three or more ribs and three or more facing ribs may be formed at intervals in the lateral direction respectively on the housing body and the pressing portion.

In the case of the first and second embodiments, the projecting portions serving as the external matter discharge portion are formed as the ribs and the facing ribs respectively on the housing body and the pressing portion. In contrast, the projecting portions serving as the external matter discharge portion may merely project respectively on the housing body and the pressing portion without taking the form of ribs.

In the case of the first and second embodiments, the projecting portions serving as the external matter discharge portion are formed as the ribs and the facing ribs respectively on the housing body and the pressing portion. In contrast, the projecting portions serving as the external matter discharge portion may be formed on one of the housing body and the pressing portion to project toward the other.

The external matter discharge portion needs not be constituted by all of the first slope portions, the second slope portion, the third slope portions, the tapered portions of the ribs and the tapered portions of the facing ribs, but may be constituted by at least one selected from these.

### LIST OF REFERENCE NUMERALS

10 . . . connector
20 . . . housing
21 . . . housing body
22 . . . cavity
23 . . . terminal fitting
24 . . . locking lance
27 . . . sealing ring
28 . . . cavity tower portion
29 . . . rubber plug
31 . . . frame portion
32 . . . upper side portion
33 . . . second slope portion (slope portion)
34 . . . rib (projecting portion)
35 . . . first slope portion (slope portion)
36 . . . inner slant
37 . . . outer slant
38 . . . tapered portion (of rib)
39 . . . third slope portion
40 . . . external matter discharge portion
41 . . . weir portion
42 . . . fitting tube portion
43 . . . back wall portion
44 . . . opening
45 . . . protecting portion
46 . . . reverse turning restricting portion
47 . . . lock arm
48 . . . lock body
49 . . . fulcrum portion
51 . . . interfering portion
52 . . . lock hole
53 . . . pressing portion
54 . . . retracted surface
55 . . . facing rib (projecting portion)
56 . . . facing inner slant
57, 57A . . . facing outer slant
58 . . . tapered portion (of facing rib)
59 . . . space
61 . . . open portion
80 . . . wire
90 . . . mating housing
91 . . . receptacle
92 . . . mating terminal fitting
93 . . . mating lock portion

1. A connector, comprising:
a housing body connectable to a mating housing from front;
a resiliently deformable lock arm extending in a front-rear direction, the lock arm locking the mating housing;
a pressing portion formed in a rear end part of the lock arm, the pressing portion releasing locking with the mating housing by being pressed toward one surface side of the housing body; and
an external matter discharge portion formed closer to the one surface side of the housing body than the pressing portion.

2. The connector of claim 1, wherein a slope portion serving as the external matter discharge portion and inclined in a direction separating from the pressing portion toward a rear side is provided at a position facing the pressing portion on the one surface side of the housing body.

3. The connector of claim 2, comprising a rib projecting from the housing body toward the pressing portion, wherein:
the slope portion includes a first slope portion on an end part on a tip side in a projecting direction of the rib.

4. The connector of claim 3, wherein an open portion, the open portion being a gap open rearward, is provided between the pressing portion and the first slope portion in a state where the pressing portion is closest to the one surface side of the housing body.

5. The connector of claim 3, wherein the slope portion includes a flat and inclined second slope portion at a position adjacent to the rib on the one surface side of the housing body.

6. The connector of claim 1, comprising a projecting portion projecting from at least one of the housing body and the pressing portion toward the other, wherein:
the projecting portion includes a tapered portion serving as the external matter discharge portion and having a thickness reduced toward the other.

7. The connector of claim 6, wherein:
the projecting portion is composed of a rib projecting from the housing body toward the pressing portion and a facing rib projecting from the pressing portion toward the housing body, and
the tapered portions of the rib and the facing rib are facing each other.
